(19) United States
(12) Patent Application Publication
(10) Pub. No.: US 2026/0229835 A1
(43) Pub. Date: Aug. 6, 2026

(54) METHOD AND SYSTEM FOR STABILIZATION OF A LASER BEAM FOR AN ENTANGLED PHOTON SOURCE

(71) Applicants: Quantum Industries GmbH, Vienna (AT); Quantum Technology Laboratories GmbH, Vienna (AT)

(72) Inventors: Lukas BULLA, Vienna (AT); Sebastian Philipp NEUMANN

(21) Appl. No.: 19/149,728

(22) PCT Filed: Jan. 26, 2024
(86) PCT No.: PCT/EP2024/051874

§ 371 Date: Jul. 21, 2025

(30) Foreign Application Priority Data
Jan. 26, 2023 (EP) 23153468.6

(51) Int. Cl. H01S 3/13; G02F 1/35

(52) U.S. Cl. CPC H01S 3/1308; G02F 1/3503; H01S 3/1305

(57) ABSTRACT

It is claimed a method of stabilization of a pump beam (10) for an entangled photon source (2), with i) generation of a polarized pump beam (10) by a pump laser (1); ii) generation of entangled photons (20) in the source (2) by pumping a non-linear element (9) in the source (2) with the pump beam (10). According to the invention the method comprises the steps iii) measurement of the pump beam (10) after the generation of the entangled photons (20) by splitting up the pump beam (10) into two part-pump beams (11) with orthogonal polarizations and detection of the two part-pump beams (11); iv) generation of a control signal (50) based on the sum of the two part-pump beams (11) and/or on the ratio of the two part-pump beams (11); v) adjustment of the pump laser (1), and/or one or more polarization adjustment means (6) arranged between the pump laser (1) and the source (2) by the control signal (50) in order to stabilize the power and/or the polarization of the pump beam (10).

The present invention provides a method for stabilization of a pump beam for an entangled photon source according to the preamble of claim 1 and a system for stabilization of a pump beam for an entangled photon source according to the preamble of claim 13.

As of today, the most efficient method of preparing entangled photons is via spontaneous parametric down-conversion (SPDC) which occurs in highly birefringent non-linear crystals. In order to generate entangled photons by spontaneous parametric down-conversion (SPDC) the non-linear crystal is pumped by a pump laser. While there are many different possibilities to fabricate and align such crystals, they all have in common that they require a pump laser with well-defined properties, such as operating mode (continuous wave or pulsed), polarization, power and wavelength.

Known stabilization schemes for lasers aim for the stabilization of the wavelength, which is vital for interferometric applications but is not directed at a constant generation rate and quality of entangled photon pairs.

It is an object of the present invention to provide an improved method and system for stabilization of a laser beam for an entangled photon source.

According to the present invention, a method of stabilization of a pump laser in an entangled photon source is provided according to claim 1.

This object is achieved by a method of stabilization of a pump beam for an entangled photon source, and preferably for stabilization of the pump beam for the generation of entangled photons, with the steps
i) generation of a polarized pump beam by a pump laser;
ii) generation of entangled photons in the source by pumping a non-linear element in the source with the pump beam.

According to the invention the method comprises the steps
iii) measurement of the pump beam after the generation of the entangled photons by splitting up the pump beam into two part-pump beams with orthogonal polarizations in a polarizing monitoring means and detection of the two part-pump beams by two detection means after the generation of the entangled photons;
iv) generation of a control signal based on the sum of the two part-pump beams and/or on the ratio of the two part-pump beams in a control means;
v) adjustment of the pump laser, and/or one or more polarization adjustment means arranged between the pump laser and the source by the control signal in order to stabilize the power and/or the polarization of the pump beam.

According to the present invention, a system of stabilization of a pump laser in an entangled photon source is provided according to claim 13.

The object is further achieved by a system for stabilization of a pump beam in an entangled photon source, and preferably for stabilization of the pump beam for the generation of entangled photons, comprising a pump laser generating a polarized pump beam and a source,
whereby the source is arranged behind the pump laser and comprises a nonlinear element for the generation of entangled photons.

According to the invention, the system comprises a polarizing monitoring means arranged between the pump laser and the source or behind the source, whereby the polarizing means comprises two output ports for splitting up the pump beam after the generation of the entangled photons into two part-pump beams with orthogonal polarizations, and
the system comprises two detection means, arranged behind the two output ports of the polarizing monitoring means, and
the system comprises a control means for controlling the power and/or the polarization of the pump beam, whereby a control loop is formed by the pump laser as actuation means, and/or by one or more polarization adjustment means as actuation means, and the polarizing monitoring means, and the detection means, and the control means,
whereby the polarization adjustment means is arranged between the pump laser and the source.

An advantage of the inventive method and inventive system is the automated stabilization of the power and/or the polarization of the pump laser leading to a stable generation of entangled photons with constant quality properties. This is realized by monitoring the pump beam after the generation of entangled photons. After the generation of the entangled photons means, that the pump beam is first used to pump the non-linear element for the generation of the entangled photons and in a second step the pump beam is split up into the two part-pump beams. The splitting up can be realized behind the source by a transmitted pump beam through the source or between the source and the pump laser by a in the source reflected or guided pump beam. Thus, by the inventive method and the inventive system it is not necessary to measure the generated entangled photons to check and stabilize the source and the properties of the entangled photons, but by monitoring the pump beam after the entangled photon generation. This eliminates the need to interrupt the entangled photon generation and key generation by quantum key distribution (QKD) for maintenance and adjustment purposes.

The power as well as the polarization is a crucial property of the pump beam which influences both the number of generated entangled photons and the state of the entangled photons.

The sum is an indicator of the alignment of the pump beam in the source. It can, among other things, indicate the coupling efficiency and photon pair production efficiency of the source. The ratio is an indicator of the source alignment and of the laser polarization. It can, among other things, indicate the quality of entanglement of the photon pairs. By the invention it is possible to monitor just the sum, or just the ratio, or the sum and the ratio one after each other of the pump beams to find the optimal alignment and thus to stabilize the source. In addition, it is possible to generate a control signal out of the combination of the sum and the ratio of the pump beams for example by a PID algorithm (proportional-integral-derivative algorithm). The latter is especially meaningful when e.g. increasing the ratio simultaneously decreases the sum, which can lead to an undesired configuration. The latter can also be used for the stabilization of the power and the polarization of the pump beam at the same time. Thus, the control signal can be generated by the sum of the two part-pump beams, or the ratio of the two partpump beams, or the sum and the ratio of the two part-pump beams.

Also, the adjustment of the pump laser and/or the one or more polarization adjustment means based on the control signal can be realized by the pump laser, or the one or more polarization adjustment means, or by the pump laser and the one or more polarization adjustment means. The combination of the adjustment of the pump laser and the one or more polarization adjustment means at the same time leads to a faster stabilization of the pump beam.

In a preferred embodiment, the control signal is an electrical signal, preferably whose magnitude is proportional to the measured sum and/or ratio of the two partpump beams. Thus, the electrical signal is proportional to the sum, or the ratio, or the sum and the ratio. The control signal can apply a correction based on proportional, integral, or derivative terms (denoted P, I, or D respectively) or a combination of that terms of the measured part pump beams.

In a preferred embodiment, the steps i) to v) form a control at or during the generation of the entangled photons by pumping the non-linear element by the pump beam. Control means here the alignment and/or the stabilization of the entangled photon source. It is essential here, that the alignment and/or stabilization is realized while the entangled photons are generated by pumping the non-linear element.

In a preferred embodiment, the control comprises
a) the generation of a pump beam in step i),
b) the measurement of the pump beam in step iii) after the generation of the entangled photon pairs in step ii),
c) the generation of a control signal based on the sum of the two part-pump beams and/or on the ratio of the two part-pump beams in step iv), and
d) the adjustment of the pump laser and/or one or more adjustment-polarizing means by the control signal in step v).

In a preferred embodiment, the control means in step iv) compares the actual value of the sum of the two part-pump beams and/or the ratio of the two partpump beams with a setpoint sum value and/or a setpoint ratio value and the control means determines and generates the control signal on the basis of the comparison. For the value of the spatial mode filter pump beam the signal of the intensity signal detection means can be used.

In a preferred embodiment, the setpoint sum value and/or the setpoint ratio value are set manually or are set by properties defined by a first adjustment of the entangled photon source. By that the properties like absorption or beam shaping of the used components in the source can be taken into account.

In a preferred embodiment, the control loop is permanently active. Permanently active means, that the entangled photons can be generated in the source while the alignment and/or stabilization takes place and while the entangled photons can be used for example for quantum communication or quantum key distribution. The advantage of the invention is that the control loop can be permanently active while generating entangled photons. An interruption of the generation of the entangled photons for adjustment or maintenance is not necessary.

In a preferred embodiment, the control loop can be deactivated at least temporarily or periodically. In order to check the power and/or the polarization of the pump beam, the control loop can be switched on again periodically for a certain time.

In a preferred embodiment, the control means is formed as a digital controller or as an analog circuit.

In a preferred embodiment, the two detection means generate a detection signal each in step iii). In a preferred embodiment, each detection signal is dependent or proportional to the intensity of one out of the two part-pump beams each. In a preferred embodiment, the control signal is generated by the sum and/or the ratio of the two detection signals of the two detection means. Thus, by generation of the control signal based on the sum of the two part-pump beams and/or on the ratio of the two part-pump beams in step iv) means that the control signal is generated based on the detection signals of the two part-pump beams from the detection means. For example, the intensity of the two part-pump beams is detected, whereby the detection signal in the detection means is proportional to the intensity of the two part-pump beams, leading to a detection signal proportional to the intensity of the two part-pump beams.

In a preferred embodiment, the detection means is a power meter, and/or a polarimeter, and/or a photodiode, and/or a thermal sensor. By this detection means the intensity of the pump beam can be detected in a precise manner. The advantage of a photodiode or power meter is the fast response time and the high resolution. The advantage of the thermal power sensor is a broad spectral range.

In a preferred embodiment, the pump beam is split up in the polarizing monitoring means after a transmission of the pump beam through the source. In this embodiment, the polarizing monitoring means is arranged behind the source. The advantage of this embodiment is, that the polarizing monitoring means and the detection means can be arranged outside of the source where is enough space.

In a preferred embodiment, the pump beam is split up in the polarizing monitoring means after a reflection of the pump beam in the source or a guidance back of the pump beam in the source towards the pump laser. In this embodiment, the polarizing monitoring means is arranged between the pump laser and the source.

In a preferred embodiment, for the arrangement of the polarizing means between the pump laser and the source the pump beam is guided in the source back to the pump laser, preferably on the same spatial mode out of the source. This can be realized by a reflection or guidance of the pump beam in the source or a loop configuration for the pump beam in the source, preferably a Sagnac-loop configuration.

In a preferred embodiment, the polarizing monitoring means comprises one or more polarizing beam splitter, and/or one or more isolator. In an embodiment with multiple elements of the polarizing monitoring means the polarization rotation elements can be arranged between the multiple elements of the polarizing monitoring means in order to enable two orthogonal output ports.

In a preferred embodiment, the two orthogonal polarizations of the two part-pump beams can be the horizontal linear polarization and the vertical linear polarization, or the 45° linear polarization and the −45° linear polarization.

The actuation means is the part of the control loop which possesses the physical variable to be controlled and on which the control means act, preferably in step v), via the control signal. The actuation means of the inventive method and system is the pump laser and/or the polarization adjustment means arranged between the pump laser and the source. The physical variable may be the electrical power for the pump laser, or the temperature, or a position of a grating in the pump laser, or a position and/or angle setting of a fiber coupler, or a polarization setting position of the polarization adjustment means or an electrical power of the polarization adjustment means, for example for liquid crystals or motorized wave plates.

In a preferred embodiment, the control signal of the ratio of the two part-pump beams is used for the adjustment of the polarization of the pump beam. By that embodiment a simple and robust stabilization method and system is provided for the adjustment of the polarization of the pump beam for the generation of entangled photons.

In a preferred embodiment, the adjustment of the polarization of the pump beam is realized by the control of the pump laser. In a preferred embodiment, the electrical power for the pump laser, or the temperature, or a position of a grating in the pump laser is controlled in order to adjust the polarization of the pump beam.

In a preferred embodiment, the adjustment of the polarization of the pump beam is realized by the control of one or more polarization adjustment means arranged between the pump laser and the source. In a preferred embodiment, the polarization rotation by the polarization adjustment means is controlled in order to adjust the polarization of the pump beam. In that embodiment, the polarization adjustment means is arranged in front of the source. Preferably there is no additional polarization changing optical element arranged between the polarization adjustment means and the source.

The adjustment of the polarization of the pump beam can also be realized by the control of the pump laser and the one or more polarization adjustment means at the same time in order to enable a fast adjustment.

In a preferred embodiment, the control signal of the sum of the two part-pump beams is used for the adjustment of the power of the pump beam. By that embodiment a simple and robust stabilization method and system is provided for the adjustment of the power of the pump beam for the generation of entangled photons.

In a preferred embodiment, the adjustment of the power of the pump beam is realized by the control of the pump laser. In a preferred embodiment, the electrical power for the pump laser, or the temperature, or a position of a grating in the pump laser is controlled in order to adjust the power of the pump beam.

In a preferred embodiment, the adjustment of the power of the pump beam is realized by the control of the polarization adjustment means arranged between the pump laser and the source. In that embodiment, the polarization adjustment means is arranged in front of a polarizing element. By changing the polarization of the pump beam in front of the polarizing element the power of the transmitted pump beam through the polarizing element is adjusted.

In a preferred embodiment, the adjustment of the power of the pump beam is realized by the control of multiple polarization adjustment means arranged between the pump laser and the source. In that embodiment, at least a first polarization adjustment means is arranged in front of a first polarizing element and at least a second polarization adjustment means is arranged behind the first polarizing element and in front of a second polarizing element. The advantage of this embodiment is that output modes of the first and second polarizing element can be used at the same time as the monitoring means arranged between the source and the pump laser.

The adjustment of the power of the pump beam can also be realized by the control of the pump laser and the control of one or more polarization adjustment means at the same time in order to enable a fast adjustment.

In addition, the adjustment of the polarization and the power of the pump beam can be realized by the control of the pump laser, and the one or more polarization adjustment means, and the control of one or more polarization adjustment means at the same time in order to enable a fast adjustment for example by a PID algorithm.

In a preferred embodiment, the polarizing element is a polarizing beam splitter, and/or a polarizer, and/or an isolator.

In a preferred embodiment, the polarization adjustment means is one or more motorized wave plates, and/or one or more motorized fiber paddles, and/or one or more motorized fiber squeezers, and/or one or more liquid crystals.

In a preferred embodiment, the adjustment of the power and of the polarization of the pump beam is realized by control of multiple polarization adjustment means arranged between the pump laser and the source. In that embodiment, at least a first polarization adjustment means is arranged between the pump laser and a polarizing element and at least a second polarization adjustment means is arranged behind the polarizing element. By changing the polarization of the pump beam in front of the polarizing element by the first polarization adjustment means the power of the transmitted pump beam through the polarizing element is adjusted. By changing the polarization of the pump beam behind the polarizing element by the at least second polarization adjustment means the polarization of the pump beam is adjusted.

In a preferred embodiment, the pump laser is a continuous wave laser generating a continuous wave pump laser beam or a pulsed laser generating a pulsed pump laser beam.

In a preferred embodiment, the source is formed as a continuous wave entangled photon source or a pulsed entangled photon source.

In a preferred embodiment, the source is a Sagnac-type entangled photon source, or an entangled photon source with crossed crystals inside a Sagnac loop, or an entangled photon source using a crystal double-pass inside a Sagnac interferometer, or a crossed crystal type entangled photon source, or an entangled photon source with one non-linear element pumped in two directions, or a BBO-type entangled photon source, or a BiBO-type entangled photon source, or a beam-displacer entangled photon source, or a parallel-crystal entangled photon source, or a folded-Mach-Zehnder type entangled photon source, or an entangled photon source based on a linear displacement interferometer, or an entangled photon source using interferometers on each entangled photon individually after creation, or a rail-cross entangled photon source, or a single-crystal single-pass entangled photon source with walk-off compensation, or entangled photon sources using group-velocity-matched non-linear crystals, or entangled photon sources with multi-SPDC interference.

In a preferred embodiment, the transmission of the laser beam can be realized via a free-space channel and/or a fiber channel.

The above and other aspects, features and advantages of the present invention will become more apparent from the following detailed description when taken in conjunction with the accompanying drawings.

### BRIEF DESCRIPTION OF THE DRAWINGS

FIG. 1: schematic diagram of a first embodiment of the inventive system for the stabilization of a pump beam with a polarizing monitoring means arranged behind the source;

FIG. 2: schematic diagram of another embodiment of FIG. 1 with a polarizing element between the pump laser and the source;

FIG. 3: schematic diagram of another embodiment of the inventive system for the stabilization of a pump beam with an isolator as polarizing monitoring means arranged between the pump laser and the source;

FIG. 4: schematic diagram of another embodiment of the inventive system for the stabilization of a pump beam with a polarizing monitoring means arranged branching off from the pump beam between the source and the pump laser;

FIG. 5: schematic diagram of another embodiment of the inventive system for the stabilization of a pump beam with a two-part polarizing monitoring means arranged between the pump laser and the source.

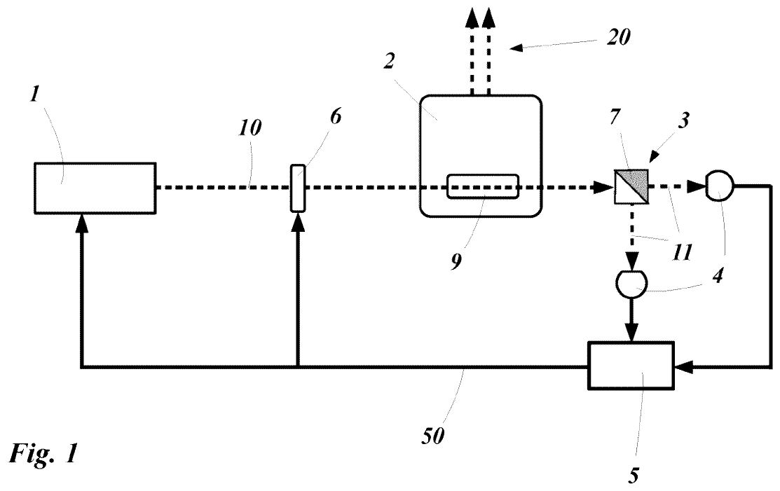

FIG. 1 shows a first embodiment of the inventive system for the stabilization of a pump beam 10 for the generation of entangled photons 20 comprising a pump laser 1 and a source 2.

The pump laser 1 generates the pump beam 10 which is guided to the source 2. The source 2 comprises a non-linear element 9 which is pumped by the pump beam 10 in order to generate the entangled photons 20.

The system comprises in addition a polarizing monitoring means, arranged in the embodiment of FIG. 1 behind the source 2. The pump beam 10 is in this embodiment transmitted through the source for the generation of the entangled photons 20 and then split by the polarizing monitoring means 3 into two part-pump beams 11. The polarizing monitoring means 3 is in the embodiment of FIG. 1 a polarizing beam splitter 7 in order to split the two part-pump beams 11 into two beams with orthogonal polarization.

Behind the two output modes of the polarizing monitoring means 3 two detection means 4 are arranged in order to detect the two part-pump beams 11. In the embodiment of FIG. 1 the two detection means 4 are power meters detecting the intensity of the two part-pump beams 11 generating two detection signals proportional to the intensity of the two part-pump beams 11.

The inventive system of FIG. 1 also comprises a control means 5, which receives the detection signals of the two detection means 4. In the control means 5 a control signal is generated by the sum or the ratio of the two detection signals. Thus, the control signal 50 is proportional to the sum or the ratio of the two partpump beams 11. In the embodiment of FIG. 1 the control signal 50 is sent to the pump laser 1 and/or to a polarization adjustment means 6. A control loop is formed by the pump laser 1 and/or a polarization adjustment means 6 as actuation means, the spatial mode filter means 3, the detection means 4 and the control means 5.

In the embodiment of FIG. 1 the polarization adjustment means 6 is a motorized wave plate or a liquid crystal and is arranged between the pump laser 1 and the source 2 in the beam path of the pump beam 10. The motorized wave plate or a liquid crystal are formed to introduce a controlled polarization rotation of the pump beam 10. The adjustment of the polarization of the pump beam 10 is realized by the control of the one or more wave plates and/or one or more liquid crystals as polarization adjustment means 6 arranged between the pump laser 1 and the source 2 by the control signal 50. For that the control signal 50 generated by the ratio of the two part-pump beams 11 is used. The control signal 50 controls the polarization rotation by the wave plate or the liquid crystal in order to adjust the polarization of the pump beam 10.

In the embodiment of FIG. 1 the control signal 50 generated by the sum of the two part-pump beams 11 is used for the adjustment of the power of the pump beam 10. The adjustment of the power of the pump beam 10 is realized by the control of the pump laser 1 by the control signal 50.

In the embodiment of FIG. 1, for a stabilization of the polarization of the pump beam 10 for example to a horizontal linear polarization, the transmitted part-pump beam 11 has to be maximized while the reflected part-pump beam 11 has to be minimized. In the embodiment of FIG. 1, for a stabilization of the power of the pump beam 10 the sum of both part-pump beams 11 has to be kept stable.

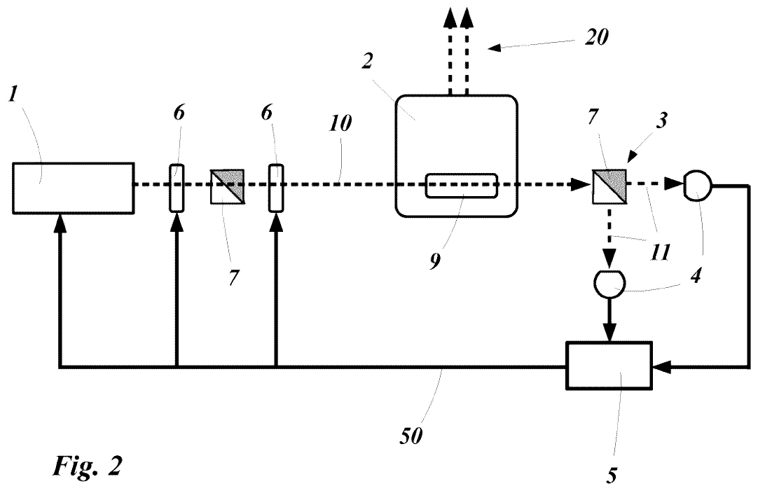

FIG. 2 shows another embodiment of the inventive system of FIG. 1, whereby FIG. 2 differs from FIG. 1 only in that between the pump laser 1 and the polarizing adjustment means 6 from FIG. 1 in front of the source in addition a polarizing beam splitter 7 as a polarizing means is arranged and a second adjustment means 6 between the pump laser 1 and the polarizing beam splitter 7 is arranged. The second adjustment means 6 is in the example of FIG. 2 one or more wave plates and/or one or more liquid crystals.

The pump laser 1 and the first polarization adjustment means 6 in front of the source 2 in FIG. 2 can be used for the adjustment of the polarization and/or the power of the pump beam 10 as described in FIG. 1.

The second adjustment means 6 in FIG. 2 between the pump laser 1 and the polarizing beam splitter 7 can be used in addition for the adjustment of the power of the pump beam 10. For that, the pump laser 1 generates the polarized pump beam 10. Only the horizontal linear polarization part of the pump beam 10 is transmitted through the polarizing beam splitter 7 in FIG. 2. By one or more wave plates and/or one or more liquid crystals as second adjustment means 6 the polarization of the pump beam 10 in front of the polarizing beam splitter 7 can be changed in order to increase or decrease the transmitted part or intensity of the pump beam 10 through the polarizing beam splitter 7, thus controlling the power of the pump beam 10 for the generation of the entangled photons 20.

In the embodiment of FIG. 2, if the power of the pump beam 10 changes, at first the second adjustment means 6 together with the polarizing beam splitter 7 can be controlled for the stabilization of the power of the pump beam 10. If this is not sufficient, in addition the pump laser 1 can be controlled for the stabilization of the power of the pump beam 10.

In the embodiment of FIG. 2, if the polarization of the pump beam 10 changes, the first adjustment means 6 in front of the source 2 can be controlled for the stabilization of the polarization of the pump beam 10.

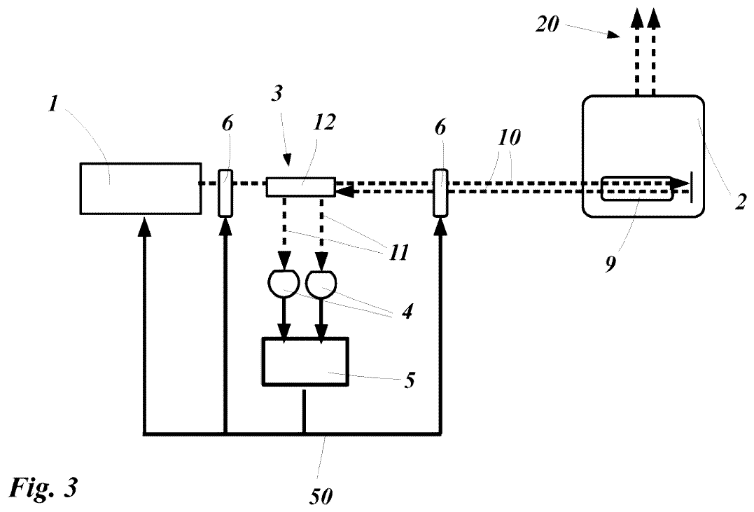

FIG. 3 shows another embodiment of the inventive system for the stabilization of a pump beam, comprising the pump laser 1, the source 2 and the polarizing monitoring means 3, whereby the polarizing monitoring means 3 is arranged in this embodiment between the pump laser 1 and the source 2 in the beam path of the pump beam 10.

In the embodiment of FIG. 3 the pump beam 10 is monitored after the generation of the entangled photons 20 by a reflection or guidance of the beam path 10 in the source 2 back to the pump laser 1. This embodiment can be used for sources 2 guiding the pump beam 10 back towards the pump laser 1, as for example a Sagnac type entangled photon source 2 or a two-direction pumped crystal source.

In the embodiment of FIG. 3 the polarizing monitoring means 3 is formed as an isolator 12. The advantage of the polarizing monitoring means 3 formed as isolator 12 is that the isolator 12 is used for cleaning the polarization of the pump beam 10 by the transmission of the pump beam 10 from the pump laser 1 to the source 2 and in addition it is used in the embodiment of FIG. 3 as polarizing monitoring means 3 with two outputs after the generation of the entangled photons 20. The two detection means 4 are arranged behind the two outputs of the isolator 12 for the pump beam 10 traveling from the source 2 to the pump laser 1.

By using a 2-port Faraday rotator-based isolator 12 the isolator 12 splits the reflected pump beam 10 into two orthogonal part-pump beams 11. As in the embodiment of FIG. 1 the two part-pump beams 11 are detected by the two detection means 4 and used for the generation of the control signal 50.

The embodiment of FIG. 3 comprises two polarization adjustment means 6, the first polarization adjustment means 6 in front of the source 2 and the second polarization adjustment means 6 between the pump laser 1 and the isolator 12.

As in the embodiment of FIG. 1 or 2, the first polarization adjustment means 6 in front of the source 2 in FIG. 3 can be used for the adjustment of the polarization as described for FIG. 1 or 2.

As in the embodiment of FIG. 1 or 2, the pump laser 1 can be used for the adjustment of the power as described for FIG. 1 or 2.

As in the embodiment of FIG. 2, the second adjustment means 6 between the pump laser 1 and the isolator 12 in FIG. 3 can be used for the adjustment of the power of the pump beam 10 as described in FIG. 2. In the embodiment of FIG. 3 the isolator 12 is used instead of the polarizing beam splitter 7.

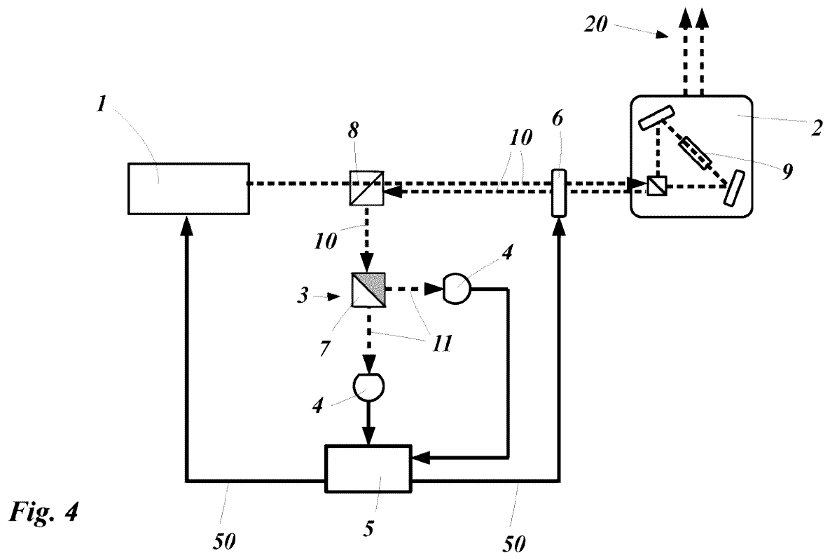

FIG. 4 shows another embodiment of the inventive system whereby FIG. 4 differs from FIG. 1 only in that the polarizing monitoring means 3 is arranged in the embodiment of FIG. 4 branching off from the pump beam 10 between the source 2 and the pump laser 1, and the pump beam 10 is reflected or guided back inside the source 2 towards the pump laser 1 as explained for FIG. 3. As an example, the non-linear element 9 is arranged in FIG. 4 in a Sagnac type source 2.

In order to monitor the pump beam 10 after a reflection in the source 2 in the embodiment of FIG. 4 a beam splitter 8 is arranged between the pump laser 1 and the first polarization adjustment means 6 in front of the source 2.

By the beam splitter 8 a part of the pump beam 10 is reflected and guided to the polarizing monitoring means 3 which is formed in the example of FIG. 4 as polarizing beam splitter 7.

The generation of the control signal 50 and the stabilization of the power and/or the polarization of the pump beam 10 can be realized in the embodiment of FIG. 4 as described for the embodiment of FIG. 1.

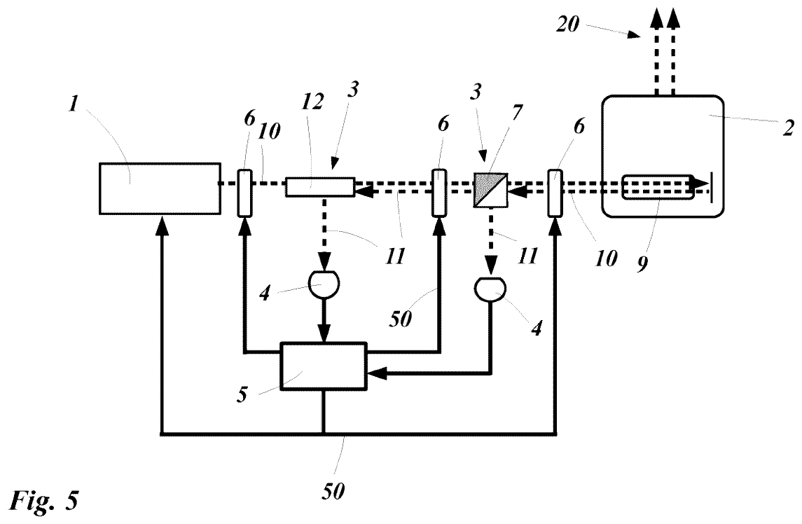

FIG. 5 shows another embodiment of the inventive system whereby FIG. 5 differs from FIG. 3 only in that between the first polarization adjustment means 6 in front of the source 2 and the isolator 12 a first part of the polarizing monitoring means 3 and a third polarization adjustment means 6 is arranged.

In the embodiment of FIG. 5 the polarizing monitoring means 3 comprises a first part formed as polarizing beam splitter 7 and a second part formed as isolator 12. Important is that the output of the isolator 12 is an orthogonal polarization to the output of the polarizing beam splitter 7.

As in the embodiment of FIG. 1 to 4, the first polarization adjustment means 6 in front of the source 2 in FIG. 5 can be used for the adjustment of the polarization as described in FIG. 1 to 4.

As in the embodiment of FIG. 1 to 4, the pump laser 1 in FIG. 5 can be used for the adjustment of the power as described in FIG. 1 to 4.

As in the embodiment of FIGS. 2 and 3, the second adjustment means 6 between the pump laser 1 and the isolator 12 in FIG. 5 can be used for the adjustment of the power of the pump beam 10 as described in FIGS. 2 and 3. In the embodiment of FIG. 5 the isolator 12 is used instead of the polarizing beam splitter 7.

In addition, in the embodiment of FIG. 5 the third adjustment means 6 formed as one or more wave plates and/or one or more liquid crystals between the isolator 12 and the polarizing beam splitter 7 can be used in addition for the adjustment of the power of the pump beam 10 as described in FIGS. 2 and 3 for the second adjustment means 6. This third adjustment means 6 is an optional adjustment means 6. For the adjustment of the power of the pump beam 10 the second adjustment means 6 is sufficient.

### Reference Signs

1 pump laser
2 source
3 polarizing monitoring means
4 detection means
5 control means
6 polarization adjustment means
7 polarizing beam splitter
8 beam splitter
9 non-linear element
10 pump beam
11 part-pump beam
12 isolator
20 entangled photons
50 control signal

1. A method of stabilization of a pump beam for an entangled photon source, and for stabilization of the pump beam for the generation of entangled photons, comprising:
i) generation of a polarized pump beam by a pump laser;
ii) generation of entangled photons in the source by pumping a non-linear element in the source with the pump beam;
iii) measurement of the pump beam after the generation of the entangled photons by splitting up the pump beam into two part-pump beams with orthogonal polarizations in a polarizing monitoring means and detection of the two part-pump beams by two detection means after the generation of the entangled photons;
iv) generation of a control signal based on the sum of the two part-pump beams or on the ratio of the two part-pump beams in a control means; and
v) adjustment of the pump laser, and one or more polarization adjustment means arranged between the pump laser and the source by the control signal in order to stabilize a power or a polarization of the pump beam.

2. The method according to claim 1, wherein the control signal is an electrical signal whose magnitude is proportional to the measured sum or ratio of the two part-pump beams.

3. The method according to claim 1,
wherein steps i) to v) form a control at or during the generation of the entangled photons by pumping the non-linear element by the pump beam.

4. The method according to claim 1,
wherein the control comprises:
a) the generation of a pump beam in step i),
b) the measurement of the pump beam in step iii) after the generation of entangled photon pairs in step ii),
c) the generation of a control signal based on the sum of the two part-pump beams or on the ratio of the two part-pump beams in step iv), and
d) the adjustment of the pump laser or one or more adjustment polarizing means by the control signal in step v).

5. The method according to claim 1,
wherein the control means in step iv) compares an actual value of the sum of the two part-pump beams or the ratio of the two part-pump beams with a setpoint sum value or a setpoint ratio value and the control means determines and generates the control signal on the basis of the comparison of the actual value of the sum of the two part-pump beams or the ratio of the two part-pump beams with the setpoint sum value or the setpoint ratio value.

6. The method according to claim 1,
wherein the two detection means generate a detection signal each in step iii), and wherein each detection signal is dependent or proportional to an intensity of one out of the two part-pump beams each.

7. The method according to claim 1,
wherein the pump beam is split up in the polarizing monitoring means after a transmission of the pump beam through the source.

8. The method according to claim 1,
wherein the pump beam is split up in the polarizing monitoring means after a reflection of the pump beam in the source or a guidance back of the pump beam in the source towards the pump laser.

9. The method according to claim 1,
wherein the control signal of the ratio of the two part-pump beams is used for the adjustment of the polarization of the pump beam.

10. The method according to claim 1,
wherein the adjustment of the polarization of the pump beam is realized by the control of the pump laser or
the adjustment of the polarization of the pump beam is realized by the control of one or more polarization adjustment means arranged between the pump laser and the source.

11. The method according to claim 1,
wherein the control signal of the sum of the two part-pump beams is used for the adjustment of the power of the pump beam.

12. The method according to claim 1,
wherein the adjustment of the power of the pump beam is realized by the control of the pump laser, or
the adjustment of the power of the pump beam is realized by the control of the polarization adjustment means arranged between the pump laser and the source, or
the adjustment of the power of the pump beam is realized by the control of multiple polarization adjustment means arranged between the pump laser and the source.

13. A system for stabilization of a pump beam in an entangled photon source and for stabilization of the pump beam for the generation of entangled photons, comprising:
a pump laser generating a polarized pump beam and;
a source, whereby the source is arranged behind the pump laser and comprises a non-linear element for the generation of entangled photons;
a polarizing monitoring means arranged between the pump laser and the source or behind the source, wherein the polarizing means comprises two output ports for splitting up the pump beam after the generation of the entangled photons into two part-pump beams with orthogonal polarizations;
two detection means, arranged behind the two output ports of the polarizing monitoring means; and
a control means for controlling the power or the polarization of the pump beam, wherein a control loop is formed by the pump laser as actuation means, or by one or more polarization adjustment means as actuation means, the polarizing monitoring means, the detection means, and the control means, whereby the polarization adjustment means is arranged between the pump laser and the source.

14. The system according to claim 13,
wherein the polarizing monitoring means comprises one or more polarizing beam splitter, or one or more of an isolator.

15. The system according to claim 13,
wherein the polarization adjustment means is one or more motorized wave plates, one or more motorized fiber paddles, one or more motorized fiber squeezers, or one or more liquid crystals.
